(19) United States
(12) Patent Application Publication
(10) Pub. No.: US 2010/0077296 A1
(43) Pub. Date: Mar. 25, 2010

(54) Methods for rendering data sets and systems thereof

(75) Inventor: Kyle Adams, West Henrietta, NY (US)

Correspondence Address: NIXON PEABODY LLP - PATENT GROUP, 1100 CLINTON SQUARE, ROCHESTER, NY, 14604, US

(73) Assignee: Blue Tie, Inc., Pittsford, NY (US)

(21) Appl. No.: 12/284,791

(22) Filed: Sep. 25, 2008

(51) Int. Cl. G06F 17/00

(52) U.S. Cl. 715/243

(57) ABSTRACT

A method, computer readable medium, and system that renders a data set includes creating a display column section for at least one column in a data grid, the display column section comprising two or more locations for data. The data is loaded in the two or more locations in the created display column section and each of the created display column sections with the loaded data is rendered for display on a display device.

### FIELD OF THE INVENTION

The present invention generally relates to systems and methods for displaying data and, more particularly, to methods for rendering data sets and systems thereof.

### BACKGROUND

Currently, one prior manner for displaying a data set involves creating a data grid and then individually loading the data into each column and row of the data grid from a server for display by the browser. Although this technique works, it often takes a lot of time and can cause the page to load very slowly and become somewhat unresponsive. Additionally, this technique drastically increases the memory foot-print of the web page, because all data must be in memory for it to work.

Another prior manner for displaying a data set also involves creating a data grid, but in this technique only the data in the visible region is individually loaded into each visible column and row. As a request to scroll down the data grid which forms the list is received, the data in the new visible region is individually loaded into each new visible column and row. As a result, dozens of cells are modified each time a request to scroll down the data grid is received. Although this technique works better, it still takes quite a bit of time and can cause the page to load slowly and become somewhat unresponsive.

### SUMMARY

A method for rendering a data set in accordance with embodiments of the present invention includes creating a display column section for at least one column in a data grid, the display column section comprising two or more locations for data. The data is loaded in the two or more locations in the created display column section and each of the created display column sections with the loaded data is rendered for display on a display device.

A computer readable medium having stored thereon instructions for rendering a data set comprising machine executable code which when executed by at least one processor, causes the processor to perform steps in accordance with other embodiments of the present invention includes creating a display column section for at least one column in a data grid, the display column section comprising two or more locations for data. The data is loaded in the two or more locations in the created display column section and each of the created display column sections with the loaded data is rendered for display on a display device.

A system that renders a data set, the system in accordance with other embodiments of the present invention includes a data grid processing system, a loading system and a display system. The data grid processing system creates a display column section for at least one column in a data grid, the display column section comprising two or more locations for data. The loading system loads data in the two or more locations in the created display column section. The data grid processing system renders each of the created display column sections with the loaded data on a display device.

The present invention provides a faster and more effective method and system for rendering a data set. With the present invention, a data set can be more quickly rendered on a display device at a requesting system. Additionally, the present invention provides an innovative manner for permitting the alteration of one or more aspects of data in the data set without losing the benefit of the faster and more efficient loading a display.

### BRIEF DESCRIPTION OF THE DRAWINGS

FIG. 1 is a block diagram of a system that renders a data set in accordance with embodiments of the present invention;

FIG. 2 is a flow chart of a method for rendering a data set in accordance with embodiments of the present invention;

FIG. 3 is a diagram of a display columns with data from a data set rendered in data grid; and

FIG. 4A is a diagram of base column sections each with a portion of data from a data set to be displayed in a data grid;

FIG. 4B is a diagram of overlay column sections each with the remaining altered portions of data from the data set to be displayed in the data grid; and

FIG. 4C is a diagram of the rendered combination of the overlay of the base overlay column sections shown in FIG. 4A with the overlay column sections in FIG. 4B.

### DETAILED DESCRIPTION

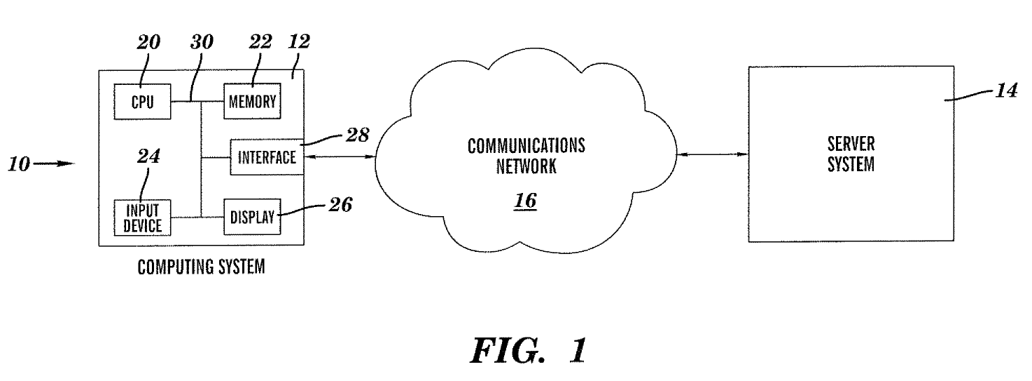

A system 10 that renders a data set in accordance with embodiments of the present invention is illustrated in FIG. 1. The system 10 includes a computing system 12, an server system 14, and a communication network 16, although the system 10 can include other types and numbers of components, device, and systems which are connected in other manners to render the data set. The present invention provides a faster and more effective method and system for rendering a data set.

Referring more specifically to FIG. 1, the computing system 12 is used to render a requested data set, although other types and numbers of systems could be used, such as application server 14, and other types and numbers of functions can be performed by the computing system 12. The computing system 12 includes a central processing unit (CPU) or processor 20, a memory 22, user input device 24, a display 26, and an interface system 28, and which are coupled together by a bus 30 or other link, although the computing system 12 can include other numbers and types of components, parts, devices, systems, and elements in other configurations. The processor 20 executes a program of stored instructions for one or more aspects of the present invention as described and illustrated herein, although the processor could execute other numbers and types of programmed instructions.

The memory 22 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory 22.

The user input device 24 in the computing system 12 is used to input selections, such as request for a data set, although the user input device 24 could be used to input other types of data and interact with other elements. The user input device 24 can include a computer keyboard and a computer mouse, although other types and numbers of user input devices can be used. The display 26 in the computing system 12 is used to show the requested data set in a data grid by way of example only. The display 26 can include a computer display screen, such as a CRT or LCD screen, although other types and numbers of displays could be used.

The interface system 28 is used to operatively couple and communicate between the computing system 12 and the server system 14 over a communication network 16, although other types and numbers of communication networks or systems with other types and numbers of connections and configurations to other types and numbers of systems, devices, and components can be used. By way of example only, the communication network 16 can use TCP/IP over Ethernet and industry-standard protocols, including SOAP, XML, LDAP, and SNMP, although other types and numbers of communication networks, such as a direct connection, a local area network, a wide area network, modems and phone lines, e-mail, and wireless communication technology, each having their own communications protocols, can be used.

The server system 14 is used to retrieve and provide the requested data set although the server system 14 can perform other types and numbers of functions and the present invention can be executed in the computing system 12 without a network connection to the server system 14 or any other system. The server system 14 includes a central processing unit (CPU) or processor, a memory, and an interface system which are coupled together by a bus or other link, although other numbers and types of each of the components and other configurations and locations for the components can be used. The processor in server system 14 executes a program of stored instructions for one or more aspects of the present invention as described herein. The memory in server system 14 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in server system 14. The interface system in server system 14 is used to operatively couple and communicate between the server system 14 and the computing system 12, although other types of connections and other types and combinations of systems could be used.

Although embodiments of the computing system 12 and server system 14 are described and illustrated herein, the computing system and server can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

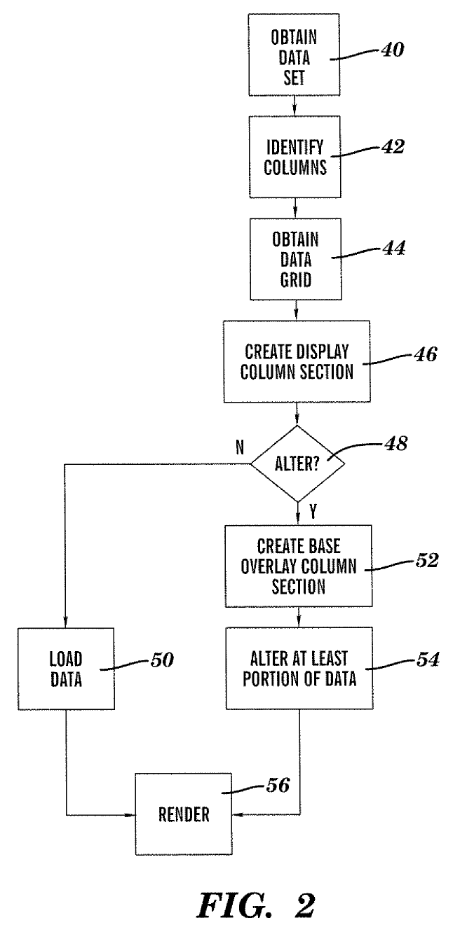

The method for rendering a data set in accordance with the exemplary embodiments will now be described with reference to FIGS. 1-4C. Although in this particular example, the processing steps described herein are substantially executed by the computing system 12 as described below, some or all of these steps can be executed by other systems, devices, or components, such as by server system 14.

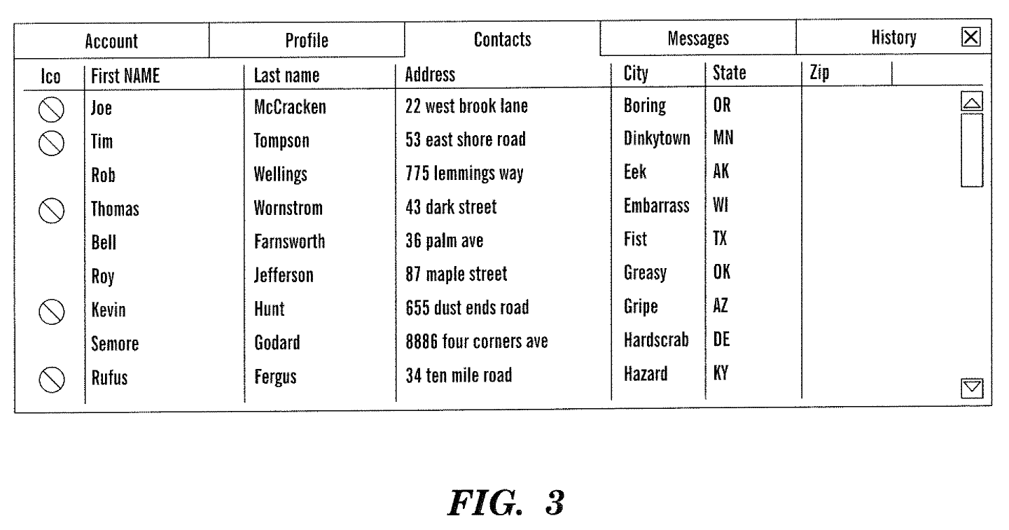

In step 40, the computing system 12 submits a request to the server system 14 for a data set, although the computing system 12 could obtain the data set from other locations, such as another database, and in other manners. The server system 14 retrieves and provides the requested data set to the computing system 12, although again the requested data set can be obtained in other manners. By way of example only, a portion of the data set provided to the computing system 12 is illustrated in FIG. 3.

In step 42, the computing system 12 identifies columns in the data set, although other manners for obtaining the columns in the requested data set can be used. By way of example only, the computing system 12 identifies the following columns in the retrieved data set shown in FIG. 3: Ico; First Name; Last Name; Address; City; State; and Zip.

In step 44, the computing system 12 creates a data grid which has the same number of columns as the requested data set for rendering a display of the requested data set, although the data grid can have other numbers of columns and can be obtained in other manners. By way of example, the computing system 12 could select and retrieve the data grid from memory 22.

In step 46, the computing system 12 creates display column sections based on the identified columns and an obtained number of locations for data in each of the display column sections, although other manners for creating the display column sections with other numbers of display column sections can be used. The number of locations for data can be determined by the user computing system 12 based on a viewing size of the display device 26, although other types and number of factors could be used to obtain the number of locations. In this particular example, the computing system 12 creates seven display columns sections which each have nine locations for data for each of the identified columns shown in FIG. 3: Ico; First Name; Last Name; Address; City; State; and Zip. By way of example only, in these embodiments each of the display column sections is an HTML element in which data for multiple locations or rows can loaded at one time with line breaks between the multiple locations or rows.

In step 48, the computing system 12 determines if an alteration to any aspect of the data in any of the display column sections is needed based on receipt of one or more requests for modification, although other manners for determining if any alterations are needed can be used. By way of example only, the alterations to some or all of the data can comprise an application of CSS styling, such as underlining, striking through, changing to bold, changing a color of, changing a font of, and changing a spacing of, although other types of alterations can be used. If the computing system 12 determines an alteration to any of the data in the requested data set is not needed, then the No branch is taken to step 50.

In step 50, the data grid in the computing system loads data from the columns of the data set into the determined number of locations in each of the corresponding display column sections, although other manners for providing the data for the determined number of locations in each of the corresponding display column sections can be used. In this particular example, the data loaded into each of the display column sections for the data grid illustrated in FIG. 3 is described in greater detail below. In particular, the data loaded from the data set into the determined locations for the first display column section for the column, “Ico” are: stop symbol; stop symbol; blank; stop symbol; blank; blank; stop symbol; blank; stop symbol. The data loaded from the data set into the determined locations for the second display column section for the column “First Name” are: Joe; Tim; Rob; Thomas; Bell; Roy; Kevin; Semore; and Rufus. The data loaded from the data set into the determined locations for the third display column section for the column, “Last Name” are: McCracken; Tompson; Wellings; Wornstrom; Farnsworth; Jefferson; Hunt; Godard; and Fergus. The data loaded from the data set into the determined locations for the fourth display column section for the column, “Address” are: 22 west brook lane; 53 east shore road; 775 lemmings way; 43 dark street; 3b palm ave; 87 maple street; 655 dust ends road; 8866 four corners ave; and 34 ten mile road. The data loaded from the data set into the determined locations for the fifth display column section for the column, “City” are: Boring; Dinkytown; Eek; Embarrass; Flat; Greasy; Gripe; Hardscrab; and Hazard. The data loaded from the data set into the determined locations for the sixth display column section for the column, “State” are: OR; MN; AK; WI; TX; OK; AZ; DE; and KY. The data loaded from the data set into the determined locations for the seventh display column section for the column, “Zip” are nine blanks because no zip codes are listed. As requests from the computing system 12 are received for additional data from the data set, additional display column sections are generated, loaded with data, and rendered.

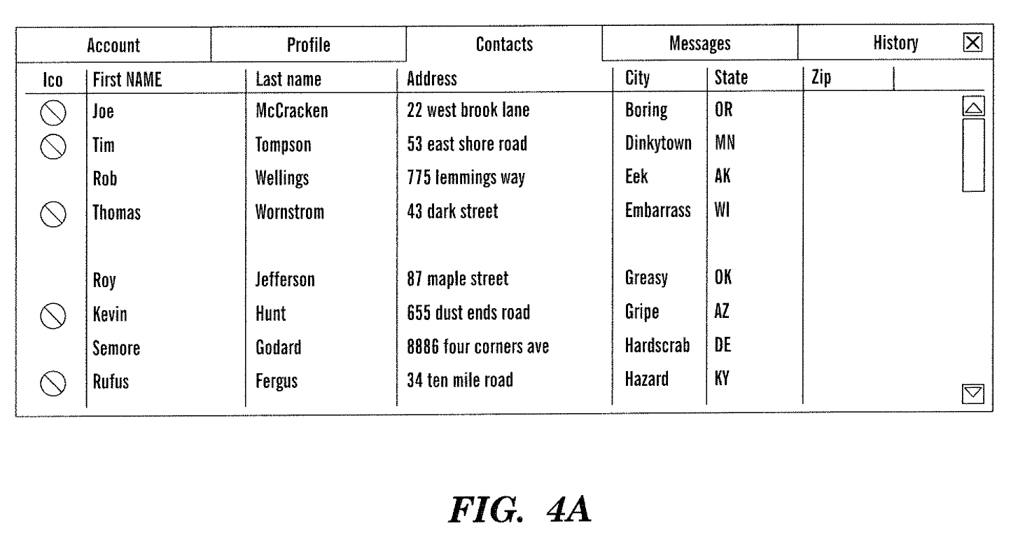

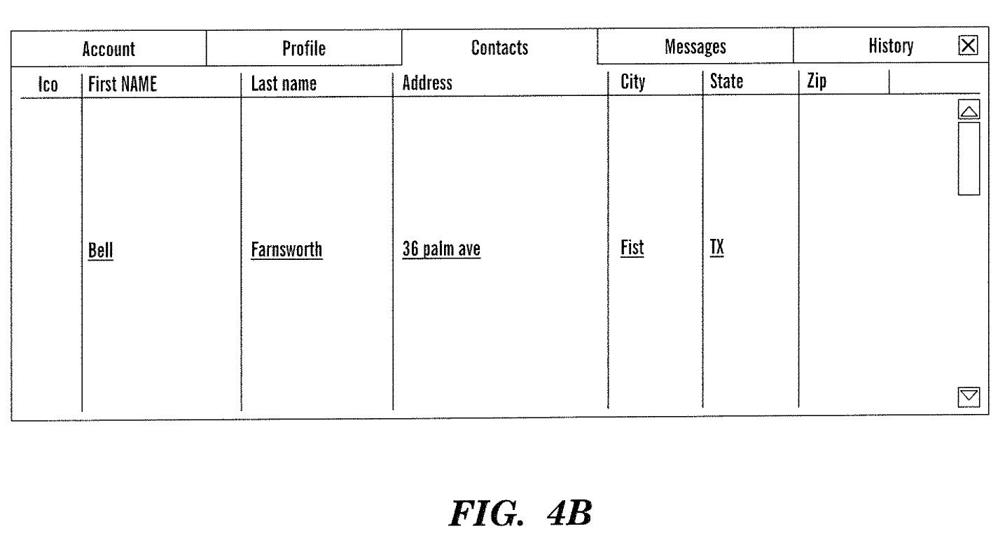

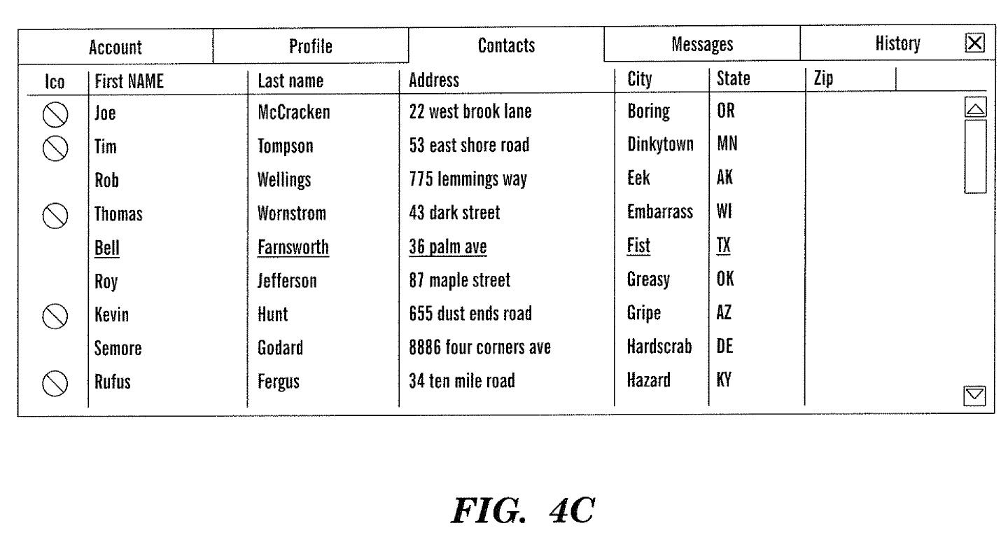

If back at step 48 the computing system 12 determines an alteration to any of the data is needed, then the Yes branch is taken to step 52. In step 52, in this particular example the data grid in the computing system 12 creates the base column sections with the data which does not need to be altered, although other numbers of and manners for creating the base column sections can be used. Additionally in this particular example the data grid in the computing system 12 creates the overlay column sections with the data which does need to be altered, although other numbers of and manners for creating the overlay column sections can be used. More specifically, the computing system 12 in this particular example creates base column sections for the columns: Ico; First Name; Last Name; Address; City; State; and Zip as shown in FIGS. 4A and creates overlay column sections for the columns: First Name; Last Name; Address; City; and State as shown in FIG. 4B

In step 54, the server system 14 alters the data in the overlay column sections by underlining the data as illustrated in FIG. 4B, although other types and numbers of alterations can be made. Again by way of example only, these alterations can comprise underlining, striking through, changing to bold, changing a color of, changing a font of, and changing a spacing of, although other types of alterations can be used.

In step 56, the computing system 12 loads unaltered data into the retrieved data grid into the base column sections illustrated in FIG. 4A and loads into the retrieved data grid the altered data into the overlay column sections illustrated in FIG. 4B, although other manners for loading the altered and unaltered data can be used.

In step 56, the data grid in the computing system 12 either renders the created display column sections with the data from step 50 as illustrated in FIG. 3 or renders a combination of the created overlay column sections over the base column sections as shown in FIG. 4C. As illustrated in the examples in FIG. 3 and 4C, the entire data set can not be shown in the data grid on the display device 26 on the computing system 12 at one time. As a result, the scrolling arrows on the right are required to submit requests to scroll down and view additional portions of this data set. The process described herein can be repeated as needed so that all of the data for the data set can be efficiently and quickly loaded in the display column sections or the base and overlay column sections and then rendered in the data grid at the display device 26 in the computing system 12.

Accordingly, as described and illustrated by the exemplary embodiment herein the present invention provides a faster and more effective method and system for rendering a data set. Additionally, the present invention provides an innovative manner for permitting the alteration of one or more aspects of data in the data set without losing the benefit of the faster and more effective method and system for rendering a data set.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A method for rendering a data set, the method comprising:
creating a display column section for at least one column in a data grid, the display column section comprising two or more locations for data;
loading data from a data set in the two or more locations in the created display column section; and
rendering each of the created display column sections with the loaded data on a display device.

2. The method as set forth in claim 1 wherein the creating further comprises creating one or more base column section and one or more overlay column sections, wherein the loading further comprises loading a different portion of the data from the data set in each of the one or more base column sections and the one or more overlay column sections, and wherein the rendering further comprises overlaying the created overlay columns sections over the corresponding one or more base column sections for display on the display device.

3. The method as set forth in claim 2 further comprising altering at least one aspect of the portion of the data in the created overlay column sections.

4. The method as set forth in claim 3 wherein the altering further comprises applying at least one CSS styling to at least a portion of the data in at least one of the created overlay column sections.

5. The method as set forth in claim 1 further comprising obtaining the data grid.

6. The method as set forth in claim 1 wherein the creating further comprises determining a number of locations of data to be loaded as one in the created display column section based on one or more factors, wherein the loading loads data in the determined number of locations as one in the created display column section.

7. The method as set forth in claim 6 wherein at least one of the one or more factors is at least one dimension of a list component on which each of the created display column sections with the loaded data are displayed.

8. A computer readable medium having stored thereon instructions for rendering a data set comprising machine executable code which when executed by at least one processor, causes the processor to perform steps comprising:
creating a display column section for at least one column in a data grid, the display column section comprising two or more locations for data;
loading data in the two or more locations in the created display column section; and
rendering each of the created display column sections with the loaded data on a display device.

9. The medium as set forth in claim 8 wherein the creating further comprises creating one or more base column section and one or more overlay column sections, wherein the loading further comprises loading a different portion of the data from the data set in each of the one or more base column sections and the one or more overlay column sections, and wherein the rendering further comprises overlaying the created overlay columns sections over the corresponding one or more base column sections for display on the display device.

10. The medium as set forth in claim 9 further comprising altering at least one aspect of the portion of the data in the created overlay column sections.

11. The medium as set forth in claim 10 wherein the altering further comprises applying at least one CSS styling to at least a portion of the data in at least one of the created overlay column sections.

12. The medium as set forth in claim 8 further comprising creating the data grid.

13. The medium as set forth in claim 8 wherein the creating further comprising determining a number of locations of data to be loaded as one in the created display column section based on one or more factors, wherein the loading loads data in the determined number of locations as one in the created display column section.

14. The medium as set forth in claim 13 wherein at least one of the one or more factors is at least one dimension of a list component on which each of the created display column sections with the loaded data are displayed.

15. A system that renders a data set, the system comprising:
a data grid processing system creates a display column section for at least one column in a data grid, the display column section comprising two or more locations for data; and
a loading system that loads data in the two or more locations in the created display column section, the data grid processing system renders each of the created display column sections with the loaded data on a display device.

16. The system as set forth in claim 15 wherein the data grid processing system creates one or more base column section and one or more overlay column sections, wherein the loading system loads a different portion of the data from the data set in each of the one or more base column sections and the one or more overlay column sections; and wherein the data grid processing system further comprises overlaying the created overlay columns sections over the corresponding one or more base column sections for display on the display device

17. The system as set forth in claim 16 wherein the data grid processing system alters at least one aspect of the portion of the data in the created overlay column sections.

18. The system as set forth in claim 17 wherein the at least one aspect altered by the data grid processing system further comprises the data grid processing system applying at least one CSS styling to at least a portion of the data in at least one of the created overlay column sections.

19. The system as set forth in claim 15 wherein the data grid processing system creates the data grid.

20. The system as set forth in claim 15 the data grid processing system determines a number of locations of data to be loaded as one in the created display column section based on one or more factors, wherein the loading system loads data in the determined number of locations as one in the created display column section.

21. The system as set forth in claim 20 wherein at least one of the one or more factors is at least one dimension of a list component on which each of the created display column sections with the loaded data are displayed.
